(19) United States
(12) Patent Application Publication
(10) Pub. No.: US 2026/0175373 A1
(43) Pub. Date: Jun. 25, 2026

(54) ELECTRIC TOOL

(71) Applicant: Makita Corporation, Anjo-shi (JP)

(72) Inventor: Takaharu NAKATSUKA, Anjo-shi (JP)

(73) Assignee: Makita Corporation, Anjo-shi (JP)

(21) Appl. No.: 19/419,579

(22) Filed: Dec. 15, 2025

(30) Foreign Application Priority Data
Dec. 19, 2024 (JP) 2024-223708

(51) Int. Cl. B25B 21/02; B25F 5/00; B25F 5/02

(52) U.S. Cl. CPC B25B 21/02; B25F 5/001; B25F 5/02

(57) ABSTRACT

A technique for improving usability of an electric tool. An electric tool includes a motor, a spindle, and a planetary gear mechanism. The spindle rotates due to a rotational force transmitted from motor. The planetary gear mechanism transmits rotational force of motor to spindle. A rotational axis of motor and a rotational axis of spindle are disposed on a same straight line. The planetary gear mechanism includes a sun gear, a plurality of planetary gears, a carrier, and an internal gear. The rotational force from motor is input to sun gear. The plurality of planetary gears is disposed on a radially outer side around a rotational axis of sun gear. The carrier is fixed non-rotatably relative to housing, and supports plurality of planetary gears rotatably on their own axes. The internal gear is rotatably disposed on radially outer side of plurality of planetary gears, and transmits rotational force to spindle.

### CROSS-REFERENCE TO RELATED APPLICATION

This application claims priority to Japanese patent application no. 2024-223708 filed on Dec. 19, 2024, the contents of which are fully incorporated herein by reference.

### TECHNICAL FIELD

The present disclosure relates to an electric tool.

### BACKGROUND

Among electric tools including a planetary gear mechanism as a speed reducer, there are some electric tools in which a rotational axis of a motor and a rotational axis of a spindle are disposed on the same straight line, and such an electric tool employs a configuration using the planetary gear mechanism in a planetary-type operation mode. In the case where the planetary gear mechanism is used in the planetary-type operation mode, a rotational force from the motor is input to a sun gear (a central gear). An internal gear (a ring gear) is fixed. A planetary gear rotates on its own axis, and revolves. A driving force is output from a carrier (a planetary carrier) supporting the planetary gear (for example, disclosed in Japanese Patent No. 4457170).

### SUMMARY

In the electric tool that causes the planetary gear mechanism to operate in the planetary type, the motor and the carrier rotate in the same direction. In other words, the spindle to which the rotational force is transmitted from the carrier also rotates in the same direction as the motor. Especially in impact tools including a hammer that applies an impact in a rotational direction among electric tools, members such as the motor, the carrier, the spindle, the hammer, and the anvil rotate in the same direction. In the case of an electric tool configured in this manner, inertia moments of these members rotating in the same rotational direction increase at the beginning of the operation and at the time of a stop, and this causes such a phenomenon that the main body of the electric tool is shaken in a direction opposite from the rotational direction of the motor. As a result, a user's hand is shaken and a heavy work load is imposed at the beginning of the operation of the electric tool and at the time of a stop of the electric tool.

One non-limiting object of the present disclosure is to provide improvement contributive to a reduction in a load imposed on a user at the time of work using an electric tool.

One non-limiting aspect of the present disclosure provides an electric tool including a motor, a spindle, a planetary gear mechanism, and a housing. The spindle rotates due to a rotational force transmitted from the motor. The planetary gear mechanism transmits the rotational force of the motor to the spindle. The housing contains at least a part of the planetary gear mechanism. A rotational axis of the motor and a rotational axis of the spindle are disposed on a same straight line. The planetary gear mechanism includes a sun gear, a plurality of planetary gears, a carrier, and an internal gear. The rotational force from the motor is input to the sun gear. The plurality of planetary gears is disposed on a radially outer side around a rotational axis of the sun gear. The carrier is fixed non-rotatably relative to the housing, and supports the plurality of planetary gears rotatably on their own axes. The internal gear is rotatably disposed on the radially outer side of the plurality of planetary gears, and transmits the rotational force to the spindle.

According to the present aspect, the planetary gear mechanism is configured to operate as a star type with the carrier non-rotatably fixed. In the case where the planetary gear mechanism operates as the star type, the motor, and the internal gear and the spindle rotate in opposite directions from each other. As a result, the present aspect allows an inertia moment due to the rotation of the motor and inertia moments due to the rotations of the internal gear and the spindle to cancel out each other, thereby succeeding in suppressing such a phenomenon that the main body of the electric tool is undesirably shaken due to the inertia moments at the beginning of an operation of the electric tool and at the time of a stop of the electric tool. Therefore, the present aspect can reduce a load imposed on a user at the time of work using the electric tool, improving the usability of the electric tool.

The rotational axis of the motor and the rotational axis of the spindle being disposed on the same straight line is not limited to the rotational axis of the motor and the rotational axis of the spindle being disposed on completely the same straight line. The rotational axis of the motor and the rotational axis of the spindle being disposed on the same straight line includes the rotational axis of the motor and the rotational axis of the spindle being disposed on substantially the same straight line. The rotational axis of the motor and the rotational axis of the spindle being disposed on the same straight line also includes the rotational axis of the motor and the rotational axis of the spindle being slightly out of alignment from the same straight line due to a manufacturing error, a clearance between rotational axes, looseness, or a backlash.

Another non-limiting aspect of the present disclosure provides an electric tool including a motor and a spindle. The spindle rotates due to a rotational force transmitted from the motor. A rotational axis of the motor and a rotational axis of the spindle are disposed in parallel with each other or on a same straight line. The motor and the spindle rotate in opposite directions from each other.

According to the present aspect, the motor and the spindle rotate in opposite directions from each other. Therefore, the present aspect allows an inertia moment due to the rotation of the motor and an inertia moment due to the rotation of the spindle to cancel out each other, thereby succeeding in suppressing such a phenomenon that the main body of the electric tool is undesirably shaken due to the inertia moments at the beginning of the operation of the electric tool and at the time of a stop of the electric tool. Therefore, the present aspect can reduce a load imposed on a user at the time of work using the electric tool, improving the usability of the electric tool.

The rotational axis of the motor and the rotational axis of the spindle being disposed in parallel with each other is not limited to the rotational axis of the motor and the rotational axis of the spindle being disposed completely in parallel with each other. The rotational axis of the motor and the rotational axis of the spindle being disposed in parallel with each other includes the rotational axis of the motor and the rotational axis of the spindle being disposed substantially in parallel with each other. The rotational axis of the motor and the rotational axis of the spindle being disposed in parallel with each other also includes the rotational axis of the motor and the rotational axis of the spindle being slightly offset from parallel layout positions due to a manufacturing error, a clearance between rotational axes, looseness, or a backlash.

### BRIEF DESCRIPTION OF THE DRAWINGS

FIG. 1 is a perspective view of an impact tool according to a first embodiment.

FIG. 2 is a vertical cross-sectional view of the impact tool.

FIG. 3 is a vertical cross-sectional view illustrating an upper portion of the impact tool.

FIG. 4 is a perspective view of a power transmission mechanism of the impact tool.

FIG. 5 illustrates the relationship between a planetary gear mechanism and a spindle.

FIG. 6 illustrates the configurations of the planetary gear mechanism and the spindle.

FIG. 7 is an exploded perspective view of the planetary gear mechanism and the spindle.

FIG. 8 illustrates the relationship between the spindle and an inner hammer.

FIG. 9 is a schematic configuration diagram of an impact tool according to a second embodiment.

### DETAILED DESCRIPTION OF THE EMBODIMENTS

In the following description, representative and non-limiting specific examples of the present invention will be described in detail with reference to the drawings. This detailed description is merely intended to teach a person of skill in the art details for practicing preferred examples of the present invention and is not intended to limit the scope of the present invention. Furthermore, each of additional features and inventions disclosed below can be utilized separately from or together with other features and inventions to provide further improved apparatuses and methods for manufacturing and using the same.

Moreover, combinations of features and steps disclosed in the following detailed description are not necessary to practice the present invention in the broadest sense, and are instead taught merely to particularly describe representative specific examples of the present invention. Furthermore, various features of the above-described and the following representative examples, as well as various features recited in the independent and dependent claims below, do not necessarily have to be combined in herein specifically exemplified manners or enumerated orders to provide additional and useful embodiments of the present invention.

In one or more non-limiting embodiments according to the present disclosure, the electric tool may further include a carrier fixation member configured to non-rotatably fix the carrier to the housing.

According to this embodiment, the carrier can be non-rotatably fixed to the housing via the carrier fixation member. Therefore, the carrier can be securely fixed so as to prohibit revolutions of the planetary gears subjected to a strong rotational force from the motor (the sun gear). As a result, the rotational force of the sun gear can be transmitted to the internal gear without being attenuated due to the planetary gears and the carrier.

In addition to or instead of the above-described embodiments, the internal gear and the spindle may be configured as separate individual members.

According to this embodiment, when the internal gear and the spindle are manufactured, they can be easily manufactured compared with such a configuration that the internal gear and the spindle are formed as an integrated member. Further, the present embodiment makes it easy to use different material as the respective materials of these members, compared with such a configuration that the internal gear and the spindle are formed as an integrated member.

In addition to or instead of the above-described embodiments, the internal gear and the spindle are connected relatively movably in an axial direction of a rotational axis of the internal gear and the spindle.

According to this embodiment, the transmission of a vibration generated in the axial direction of the rotational axis from the spindle to the internal gear can be suppressed when the electric tool is driven. As a result, the durability of the planetary gear mechanism can be improved.

In addition to or instead of the above-described embodiments, the internal gear and the spindle are connected via a spline extending in the axial direction of the rotational axis of the internal gear and the spindle.

According to this embodiment, the electric tool can have a structure excellent in the capability of transmitting power exerted in the rotational direction from the internal gear to the spindle and the self-aligning ability while suppressing the transmission of the vibration generated in the axial direction of the rotational axis from the spindle when the electric tool is driven.

In addition to or instead of the above-described embodiments, the carrier fixation member may include a gear-shaped first engagement portion on which a plurality of teeth is formed circumferentially around the rotational axis of the sun gear. The housing may include a second engagement portion fittable to the first engagement portion.

According to this embodiment, the carrier fixation member is fixed to the housing due to the circumferential gear shape, and this can make it easy for the housing to receive the force of the carrier in the rotational direction. As a result, the carrier can be indirectly fixed to the housing securely.

In addition to or instead of the above-described embodiments, the carrier may be a metallic member. The carrier fixation member may be a resin member.

According to this embodiment, while the carrier, to which the force is transmitted from the planetary gears, can be enhanced in strength by being formed as a metallic member, the carrier fixation member can be reduced in weight by being formed as a resin member.

In addition to or instead of the above-described embodiments, the electric tool may include a hammer disposed around the spindle and provided rotatably in the same direction as the spindle due to the rotational force of the spindle. The electric tool may include an anvil at least partially disposed on a front side with respect to the spindle and configured to be impacted in a rotational direction by the hammer.

According to this embodiment, the inertia moment due to the rotation of the motor and the inertia moment due to the rotation of the hammer can cancel out each other, and this can contribute to suppressing such a phenomenon that the main body of the electric tool is undesirably shaken in the rotational direction at the beginning of the operation and at the time of a stop, thereby improving the usability of the electric tool.

In addition to or instead of the above-described embodiments, an electric tool including a motor and a spindle may be employed. The spindle may rotate due to a rotational force transmitted from the motor. A rotational axis of the motor and a rotational axis of the spindle may be disposed in parallel with each other or on a same straight line. The motor and the spindle may rotate in opposite directions from each other.

According to this embodiment, the motor and the spindle rotate in opposite directions from each other. Therefore, this embodiment allows an inertia moment due to the rotation of the motor and an inertia moment due to the rotation of the spindle to cancel out each other, thereby succeeding in suppressing such a phenomenon that the main body of the electric tool is undesirably shaken due to the inertia moments at the beginning of the operation of the electric tool and at the time of a stop of the electric tool, thus improving the usability of the electric tool.

In addition to or instead of the above-described embodiments, the electric tool may include a planetary gear mechanism configured to transmit the rotational force of the motor to the spindle. The planetary gear mechanism may include a sun gear, a planetary gear, a carrier supporting the planetary gear rotatably on its own axis, and an internal gear.

The rotational force of the motor may be input to the sun gear. The carrier may be non-rotatably fixed. The internal gear may be rotatable. A rotational force of the internal gear may be output to the spindle.

According to this embodiment, the planetary gear mechanism is configured to operate as a star type with the carrier non-rotatably fixed. In the case where the planetary gear mechanism operates as the star type, the rotational direction of the motor is opposite to those of the internal gear and the spindle. As a result, the present embodiment allows the inertia moment due to the rotation of the motor and the inertia moments due to the rotations of the internal gear and the spindle to cancel out each other, thereby succeeding in suppressing such a phenomenon that the main body of the electric tool is undesirably shaken due to the inertia moments at the beginning of an operation of the electric tool and at the time of a stop of the electric tool, thus improving the usability of the electric tool.

### A. First Embodiment

As one example of an electric tool according to one representative and non-limiting embodiment of the present disclosure, an impact tool 1 will be described in detail with reference to the drawings. First, the configuration of the impact tool 1 will be described. After that, the operation of the impact tool 1 will be described.

### Configuration of Impact Tool

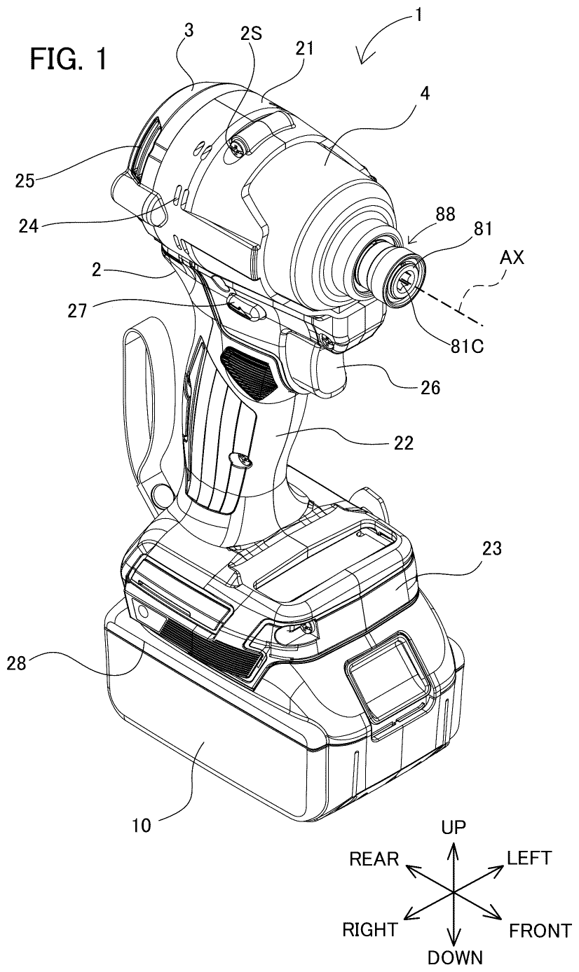

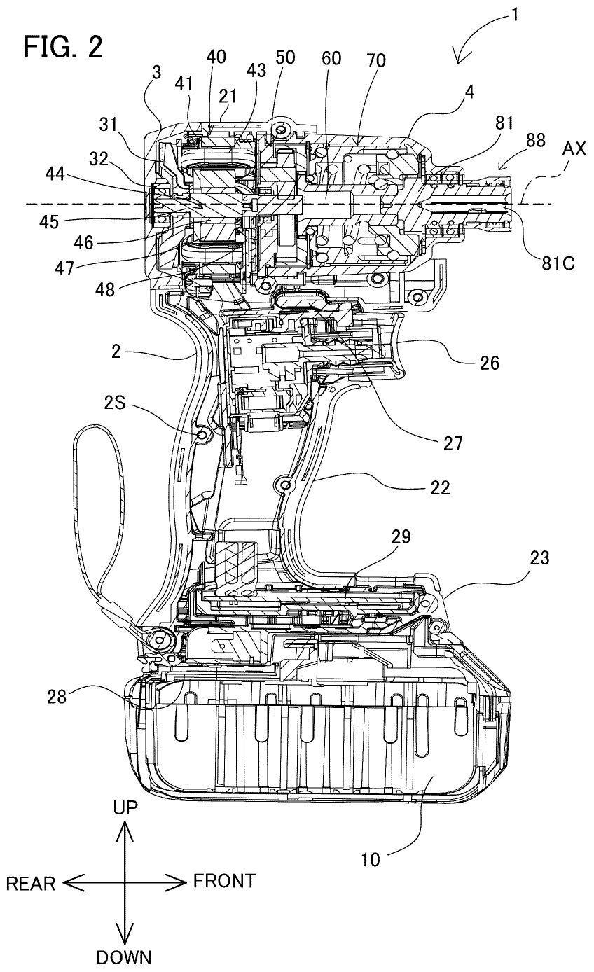

The configuration of the impact tool 1 will be described with reference to FIGS. 1 to 3. In the present embodiment, the impact tool 1 is an impact driver.

The impact tool 1 is an electric tool that realizes screw tightening work by rotating an anvil 81 while applying an impact in a rotational direction to a tool accessory (for example, a driver bit) inserted in this anvil 81. More specifically, when the user operates and pulls a trigger lever 26, which is an operation unit disposed on a grip portion 22 of the impact tool 1, electric power is supplied from a battery pack 10 to a motor 40 via a controller 29, and a rotor 44 provided to the motor 40 rotates. A rotational force output from the motor 40 is transmitted to a spindle 60 via a planetary gear mechanism 50, which functions as a speed reducer. The rotational force transmitted to the spindle 60 is transmitted to the anvil 81 via an inner hammer 78, which is a part of an impact mechanism 70. The rotation of the anvil 81 causes a rotation of the tool accessory inserted in the anvil 81, realizing the screw tightening work. If resistance in the rotational direction is generated between a screw and a workpiece and a predetermined or more load is imposed on the anvil 81 at the time of the screw tightening work, an impact force is applied to the anvil 81 from the inner hammer 78 and an outer hammer 73, which are a part of the impact mechanism 70. The anvil 81 rotates the screw while applying the rotational force and the impact force in the rotational direction to the screw. In this manner, the impact tool 1 realizes the screw tightening work.

In the present embodiment, a front-rear direction is defined to be a direction parallel with a rotational axis AX of the motor 40. A front side and a rear side are defined to be one side in the front-rear direction on which the spindle 60 is disposed with respect to the motor 40, and the opposite side from the front side, respectively. A vertical direction is defined to be a direction in which the grip portion 22 extends among directions perpendicular to the axial direction of the rotational axis AX. A lower side and an upper side are defined to be one side in the vertical direction on which the grip portion 22 is disposed with respect to the motor 40, and the opposite side from the lower side, respectively. A left-right direction of the impact tool 1 is defined to be a direction orthogonal to the vertical direction and the front-rear direction.

The impact tool 1 includes a main body housing 2, a rear cover 3, and a hammer housing 4. The main body housing 2 is made from synthetic resin. The main body housing 2 is constituted by a pair of half-divided housings, which are formed by a right-side housing and a left-side housing. The right-side housing and the left-side housing are fixed using a plurality of screws 2S.

The main body housing 2 includes a motor containing portion 21, the grip portion 22, and a battery holding portion 23.

The motor containing portion 21 is tubularly shaped, and contains the motor 40 therein. Further, the motor containing portion 21 contains a part of the hammer housing 4. The inner configuration of the motor containing portion 21 will be described below.

The grip portion 22 is gripped by the user when the impact tool 1 is in use. The grip portion 22 extends downward from the motor containing portion 21. The trigger lever 26 and a forward-reverse rotation switching lever 27 are disposed on the upper portion of the grip portion 22. The trigger lever 26 is an operation unit operated by the user to actuate the motor 40. When the trigger lever 26 is operated by being pulled by the user, the motor 40 is driven. When the user releases the pulling operation of the trigger lever 26, the motor 40 is stopped. The forward-reverse rotation switching lever 27 is an operation unit operated by the user to switch the rotational direction of the motor 40 from one of a forward direction and a reverse direction to the other of them. When the rotational direction of the motor 40 is switched, the rotational direction of the spindle 60 and the anvil 81 is switched.

The battery holding portion 23 is connected to the lower end portion of the grip portion 22. The battery holding portion 23 holds the battery pack 10 via a battery mount portion 28. The dimension of the outer shape of the battery holding portion 23 is larger than the dimension of the outer shape of the grip portion 22 in the front-rear direction and the left-right direction.

The rear cover 3 is disposed so as to cover an opening at the rear end portion of the motor containing portion 21. The rear cover 3 is made from synthetic resin. The rear cover 3 contains at least a part of a fan 31. Further, the rear cover 3 contains a rear-side rotor bearing 32. The rear-side rotor bearing 32 rotatably supports the rear end of a rotor shaft 45 provided to the motor 40.

The motor containing portion 21 includes an intake port 24. The rear cover 3 includes an exhaust port 25. A rotation of the fan 31 causes air outside the main body housing 2 to flow into the inner space of the main body housing 2 via the intake port 24. The air in the inner space of the main body housing 2 flows out to a space outside the main body housing 2 via the exhaust port 25.

The fan 31 is disposed between a stator 41 (the motor 40) and the rear-side rotor bearing 32. The fan 31 is fixed to the rear portion of the rotor shaft 45 of the motor 40. When the motor 40 is actuated, the fan 31 rotates together with the rotor shaft 45, and generates an airflow for cooling the motor 40. The rotation of the fan 31 causes the air in the space outside the main body housing 2 to flow into the inner space of the main body housing 2 via the intake port 24. The air introduced into the inner space of the main body housing 2 cools the motor 40 by flowing through the inner space of the main body housing 2. After flowing through the inner space of the main body housing 2, the air flows out to the space outside the main body housing 2 via the exhaust port 25 due to the rotation of the fan 31.

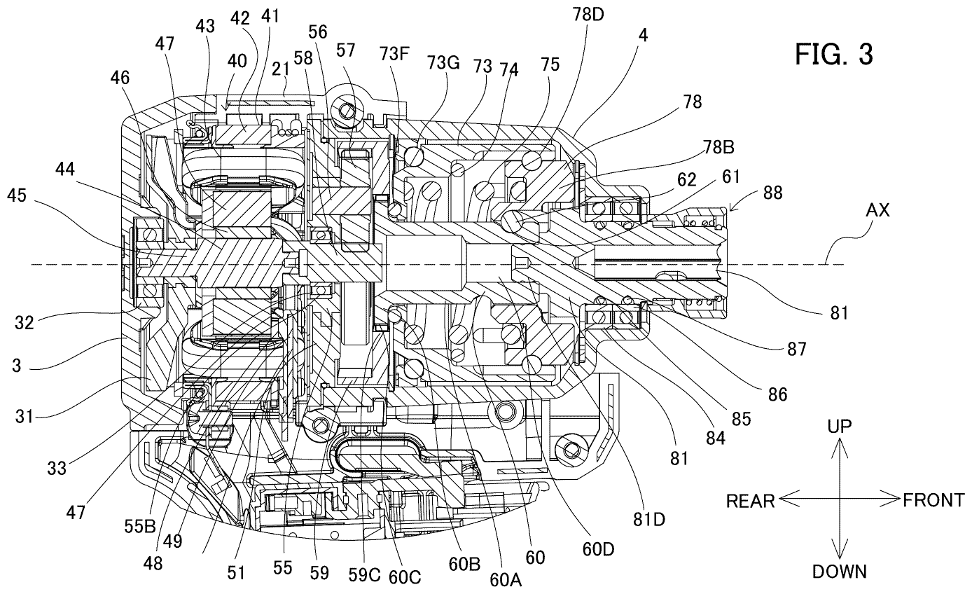

The motor 40 will be described with reference to FIG. 3. The motor 40 is a power source of the impact tool 1. The motor 40 is an inner rotor-type brushless motor. The motor 40 includes the stator 41 and the rotor 44.

The stator 41 is supported in the motor containing portion 21. The stator 41 includes a stator core 42 and a coil 43.

At least a part of the rotor 44 is disposed inside the stator 41. The rotor 44 rotates relative to the stator 41. The rotor 44 rotates about the rotational axis AX extending in the front-rear direction. The rotor 44 includes the rotor shaft 45, a rotor core 46, a rotor magnet 47, and a sensor magnet 48.

The rotor shaft 45 and the rotor core 46 are each made from steel. In the embodiment, the rotor shaft 45 and the rotor core 46 are integrated. The front portion of the rotor shaft 45 protrudes forward from the front end surface of the rotor core 46. The rear portion of the rotor shaft 45 protrudes rearward from the rear end surface of the rotor core 46.

The rotor magnet 47 is fixed to the rotor core 46. In the present embodiment, the rotor magnet 47 is disposed around the rotor core 46. The sensor magnet 48 is fixed to the rotor core 46. In the embodiment, the sensor magnet 48 is disposed on the front end surface of the rotor core 46.

A sensor board 49 is disposed at the front end of the stator 41. The sensor board 49 includes an annular circuit board and a rotation detection element supported on the circuit board. At least a part of the sensor board 49 faces the front end surface of the sensor magnet 48. The rotation detection element detects the position of the rotor 44 in the rotational direction by detecting the position of the sensor magnet 48.

The rear end portion of the rotor shaft 45 is rotatably supported by the rear-side rotor bearing 32. The rear-side rotor bearing 32 is held by the rear cover 3.

A pinion gear 58 is fixed at the front end portion of the rotor shaft 45. The rotor shaft 45 is connected to the planetary gear mechanism 50, which is the speed reducer, via the pinion gear 58. The pinion gear 58 functions as a sun gear of the planetary gear mechanism 50. In other words, power (the rotational force) of the motor 40 is input to the planetary gear mechanism 50 via the pinion gear 58. The power of the motor 40 is output from the tool accessory via the power transmission mechanism including the planetary gear mechanism 50, the spindle 60, the impact mechanism 70, and the anvil 81.

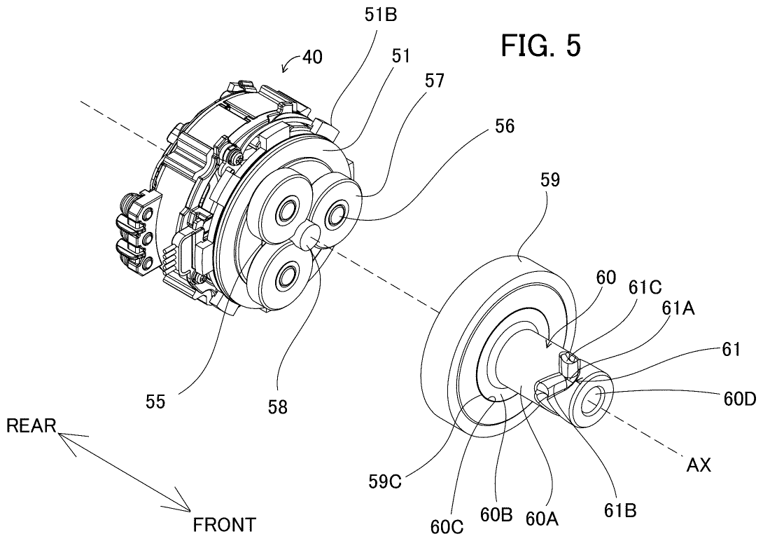

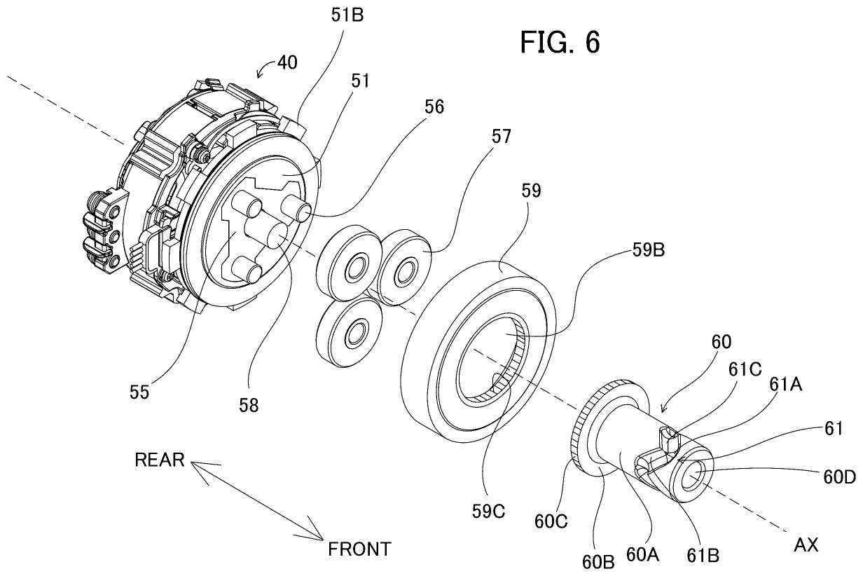

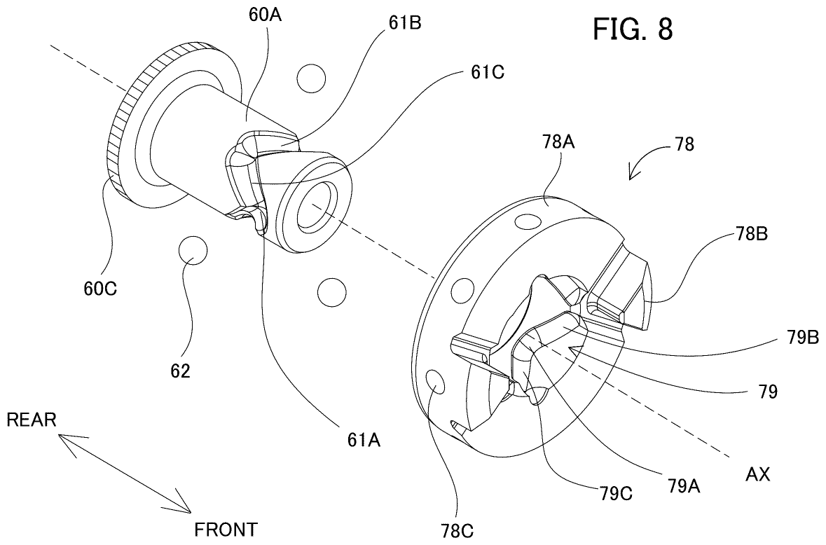

The power transmission mechanism, which transmits the power of the motor 40, will be described with reference to FIGS. 3 to 8.

The planetary gear mechanism 50 will be described. The planetary gear mechanism 50 according to the present embodiment is configured to operate as a star type. Generally, a sun gear is rotatable in the case where the planetary gear mechanism operates as the star type. A planetary gear can rotate on its own axis. A carrier supporting the planetary gear is non-rotatably fixed. Since the carrier supporting the planetary gear is non-rotatably fixed, the planetary gear cannot revolve about the sun gear although being rotatable its own axis. An internal gear is rotatable. Now, the configuration of the planetary gear mechanism 50 will be specifically described.

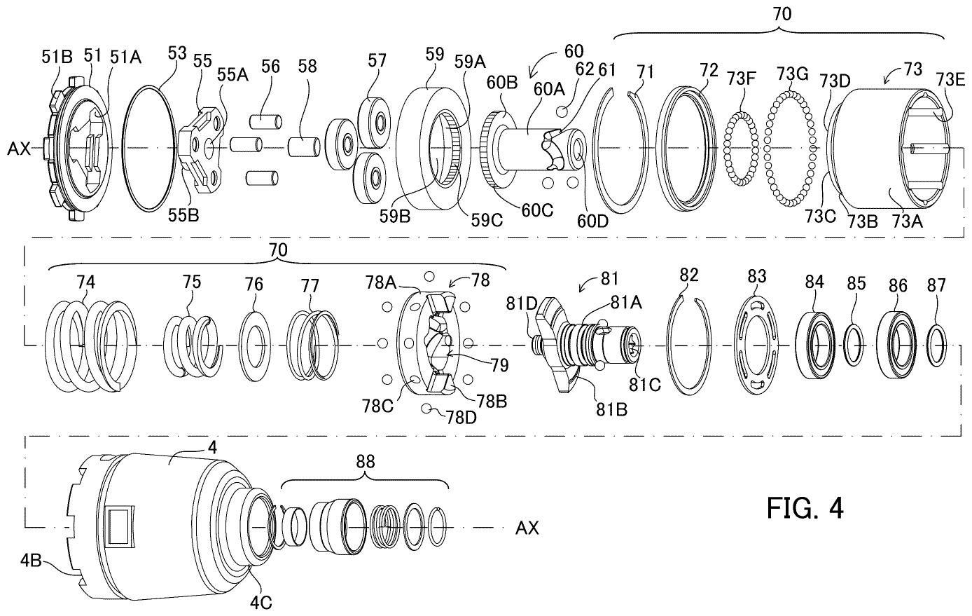

As illustrated in FIG. 4, the planetary gear mechanism 50 includes a carrier fixation member 51, an O-ring 53, a carrier 55, gear shaft pins 56, planetary gears 57, the pinion gear 58, and an internal gear 59.

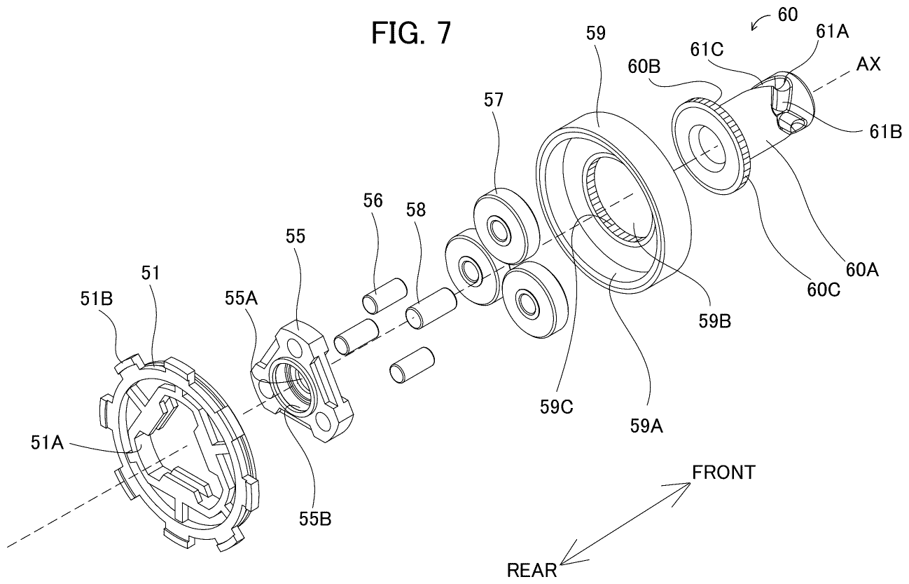

An opening portion 55A is formed at the central portion of the carrier 55. A circular groove-shaped bearing fixation portion 55B is formed at the central portion of the rear side of the carrier 55 (FIG. 7). The opening portion 55A and the bearing fixation portion 55B are in communication with each other. The pinion gear 58 extends through the opening portion 55A. A front-side rotor bearing 33 is held on the bearing fixation portion 55B from the rear side of the carrier 55. The front-side rotor bearing 33 functions as a bearing of the pinion gear 58. As described above, the pinion gear 58 is connected to the rotor shaft 45 of the motor 40. The power of the motor 40 is input to the planetary gear mechanism 50 via the pinion gear 58.

The pinion gear 58 functions as the sun gear of the planetary gear mechanism 50. Three planetary gears 57 are disposed radially externally around the rotational axis of the pinion gear 58. Each of the planetary gears 57 is supported on the carrier 55 rotatably on its own axis due to the gear shaft pin 56. The pinion gear 58 and the three planetary gears 57 are meshed with each other. A rotation of the pinion gear 58 causes each of the planetary gears 57 to rotate with the gear shaft pin 56 serving as a rotational axis therefor.

A holding portion 51A, which is a through-hole, is formed through the carrier fixation member 51. The carrier 55 is held by being fitted to the holding portion 51A. In the present embodiment, the carrier 55 is a metallic member, and the carrier fixation member 51 is a resin member. The carrier 55, to which a force is transmitted from the planetary gears 57, can be enhanced in strength by being formed as a metallic member. Further, the carrier fixation member 51 can be reduced in weight by being formed as a resin member. In the present embodiment, the carrier 55 and the carrier fixation member 51 are integrally molded by insert-molding.

A gear-shaped first engagement portion 51B is formed on the peripheral edge portion of the carrier fixation member 51. A second engagement portion 4B, which is fitted to the first engagement portion 51B of the carrier fixation member 51, is formed on the hammer housing 4. A tooth portion and a groove portion in the front-rear direction are formed on the second engagement portion 4B. The carrier fixation member 51 is securely fixed so as to be prohibited from rotating around the rotational axis AX with the aid of fitted engagement between the first engagement portion 51B of the carrier fixation member 51 and the second engagement portion 4B of the hammer housing 4.

Because the carrier fixation member 51 is fixed to the hammer housing 4 and the carrier 55 is fixed to the carrier fixation member 51, the carrier 55 is fixed non-rotatably in the rotational direction around the rotational axis AX. In other words, the carrier 55 is fixed non-rotatably relative to the hammer housing 4, which corresponds to the sun gear. Therefore, when the motor 40 is driven to rotate the pinion gear 58, the three planetary gears 57 supported on the carrier 55 rotate on their own axes, but do not revolve around the sun gear (the pinion gear 58).

The O-ring 53 is disposed between the carrier fixation member 51 and the hammer housing 4. The inside of the hammer housing 4 is filled with grease. The provision of the O-ring 53 between the carrier fixation member 51 and the hammer housing 4 can suppress a leak of the grease to outside the hammer housing 4 via a connection portion between the carrier fixation member 51 and the hammer housing 4.

The internal gear 59 is disposed outside the three planetary gears 57. The internal gear 59 is tubular. A flat surface is formed on the front side of the tubular shape of the internal gear 59, and a circular opening portion 59B is formed on this flat surface. The internal gear 59 contains the three planetary gears 57 inside the tubular shape thereof. The internal gear 59 includes a gear formed on an inner wall 59A of the tubular shape thereof, which is meshed with each of the three planetary gears 57.

When the motor 40 is driven to rotate the rotor shaft 45, the pinion gear 58, which serves as the sun gear, rotates in the same direction as the rotor shaft 45. Due to the rotation of the pinion gear 58, the three planetary gears 57 rotate on their own axes with the gear shaft pins 56 serving as rotational axes therefor. At this time, the three planetary gears 57 do not revolve. Then, the internal gear 59 rotates due to the rotations of the three planetary gears 57 on their own axes. When being viewed from the direction of the rotational axis AX, the pinion gear 58 and the internal gear 59 rotate in opposite directions from each other. The internal gear 59 is connected rotatably together with the spindle 60, which will be described below. In other words, the rotor 44 of the motor 40, and the internal gear 59 and the spindle 60 rotate in opposite directions from each other.

Employing such a configuration allows an inertia moment derived from the rotor 44 due to the rotation of the motor 40 and inertia moments due to the rotations of the internal gear 59 and the spindle 60 to cancel out each other when the impact tool 1 is driven, contributing to suppressing such a phenomenon that the main body of the impact tool 1 is undesirably shaken due to the inertia moments at the beginning of the operation of the impact tool 1 and at the time of a stop of the impact tool 1.

Further, the impact tool 1 according to the present embodiment includes the outer hammer 73 and the inner hammer 78, which will be described below. When the motor 40 rotates, the internal gear 59, the spindle 60, the outer hammer 73, and the inner hammer 78 rotate in the same direction. Therefore, when the impact tool 1 is driven, the inertia moment derived from the rotor 44 due to the rotation of the motor 40 and the inertia moments due to the internal gear 59, the spindle 60, the outer hammer 73, and the inner hammer 78 cancel out each other, and this can contribute to suppressing such a phenomenon that the main body of the impact tool 1 is undesirably shaken due to the inertia moments at the beginning of the operation of the impact tool 1 and at the time of a stop of the impact tool 1. The impact tool 1 employs weights, shapes, and layout positions of members designed in such a manner that the magnitude of the inertia moment derived from the rotor 44 due to the rotation of the motor 40 and the magnitude of the inertia moments due to the internal gear 59, the spindle 60, the outer hammer 73, and the inner hammer 78 approximately match each other.

Further, the impact tool 1 according to the present embodiment does not include a member such as a bearing for shaft alignment of the internal gear 59. Now, a reason therefor will be described.

The rotor shaft 45 is rotatably supported by the rear-side rotor bearing 32. The pinion gear 58 fixed to the rotor shaft 45 is rotatably supported by the front-side rotor bearing 33. Therefore, the axis line of the rotational axis of the pinion gear 58 connected to the rotor shaft 45 and the axis line of the rotational axis AX of the motor 40 coincide with each other. In other words, the pinion gear 58 is in a shaft aligned state, and is in such a state that the rotational axis of the pinion gear 58 is arranged at a proper position.

The planetary gears 57 are also in a shaft aligned state. More specifically, the rotational axes of the planetary gears 57 are arranged at proper positions with the aid of the carrier fixation member 51, the carrier 55, and the gear shaft pins 56.

When the shafts are aligned for two types of gears among the three types of gears (the sun gear, the planetary gears, and the internal gear) in the planetary gear mechanism 50, the shaft of the remaining one type of gear is aligned even without a bearing or the like provided therefor due to the self-aligning ability. In the case of the present embodiment, two types of gears, i.e., the pinion gear 58 as the sun gear and the planetary gears 57 are in a shaft aligned state. Therefore, the rotational axis of the internal gear 59 coincides with the rotational axis AX of the motor 40 even without the provision of a member such as a bearing intended for the shaft alignment of the internal gear 59. In other words, the impact tool 1 according to the present embodiment does not have to be provided with a bearing for the shaft alignment of the internal gear 59. As a result, the impact tool 1 according to the present embodiment can achieve the simplification of the structure, a weight reduction, and a cost reduction.

The internal gear 59 includes a connection portion 59C, which is used for a connection with the spindle 60, on the peripheral edge of the opening portion 59B. On the other hand, the spindle 60 includes a connection portion 60C for a connection with the internal gear 59. The connection portion 59C of the internal gear 59 and the connection portion 60C of the spindle 60 are connected via a spline extending in the axial direction of the rotational axis AX. In other words, the internal gear 59 and the spindle 60 are connected relatively movably in the axial direction of the rotational axis AX. This can suppress a transfer of a vibration generated in the axial direction of the rotational axis AX that is transmitted from the spindle 60 to the internal gear 59 when the impact tool 1 is driven. As a result, the durability of the planetary gear mechanism 50 can be improved. Further, the connection between the internal gear 59 and the spindle 60 via the spline can achieve a structure excellent in the capability of transmitting the rotational force from the internal gear 59 to the spindle 60 and the self-aligning ability.

This is the configuration of the planetary gear mechanism 50. Next, another configuration in the power transmission mechanism for transmitting the power of the motor 40 will be described.

The spindle 60 is disposed in front of the planetary gear mechanism 50. The spindle 60 rotates around the rotational axis AX by the motor 40. The spindle 60 rotates due to the rotational force of the rotor 44 transmitted via the planetary gear mechanism 50. More specifically, the spindle 60 rotates due to the rotational force transmitted via the connection portion 59C provided to the internal gear 59 of the planetary gear mechanism 50 and the connection portion 60C provided to the spindle 60. The spindle 60 outputs the rotational force of the motor 40 transmitted from the planetary gear mechanism 50 to the impact mechanism 70, which will be described below.

The spindle 60 includes a spindle shaft portion 60A, a flange portion 60B, the connection portion 60C, a distal-end opening portion 60D, and spindle grooves 61. The spindle shaft portion 60A has a rod-like shape elongated in the front-rear direction. The central axis of the spindle shaft portion 60A and the rotational axis AX coincide with each other. The flange portion 60B extends from the rear end portion of the outer peripheral surface of the spindle shaft portion 60A radially outward. A spline shape in the axial direction of the rotational axis AX is formed on the peripheral edge of the side surface of the flange portion 60B as the connection portion 60C. As described above, the spline shape in the axial direction of the rotational axis AX is also formed on the connection portion 59C of the internal gear 59. The connection portion 59C of the internal gear 59 and the connection portion 60C of the spindle 60 are connected via the spline extending in the axial direction of the rotational axis AX.

The distal-end opening portion 60D is provided at the distal end of the spindle shaft portion 60A. An anvil protrusion portion 81D of the anvil 81, which will be described below, is inserted in the distal-end opening portion 60D.

The spindle 60 includes the spindle grooves 61 on the outer peripheral surface of the spindle shaft portion 60A. Three spindle grooves 61 are provided on the outer peripheral surface of the spindle shaft portion 60A. One spindle groove 61 includes a central spindle groove portion 61A, a first spindle groove portion 61B, and a second spindle groove portion 61C. The central spindle groove portion 61A is located at the front end of the spindle groove 61. The first spindle groove portion 61B extends from the central spindle groove portion 61A toward one circumferential side rearward obliquely. The second spindle groove portion 61C extends from the central spindle groove portion 61A toward the other circumferential side rearward obliquely. One ball 62 is disposed in each of the spindle grooves 61. More specifically, one ball 62 is disposed between each of hammer grooves 79 provided to the inner hammer 78, which will be described below, and each of the spindle grooves 61. A rotational force of the spindle 60 is transmitted to the inner hammer 78 via the balls 62. The behaviors of the balls 62 and the inner hammer 78 when the spindle 60 rotates will be described below.

Next, the impact mechanism 70 will be described. The impact mechanism 70 is driven by the motor 40. The rotational force of the motor 40 is transmitted to the impact mechanism 70 via the planetary gear mechanism 50 and the spindle 60. The impact mechanism 70 impacts the anvil 81 in the rotational direction based on the rotational force of the spindle 60 rotating by the motor 40. The impact mechanism 70 includes a spiral retaining ring 71, a retainer 72, the outer hammer 73, balls 73F, balls 73G, a first coil spring 74, a second coil spring 75, a washer 76, a support coil spring 77, and the inner hammer 78.

The inner hammer 78 impacts the anvil 81 in the rotational direction around the rotational axis AX. The inner hammer 78 is supported on the spindle 60. The inner hammer 78 is disposed around the spindle shaft portion 60A.

The inner hammer 78 includes a hammer main body portion 78A, hammer protrusion portions 78B, and the hammer grooves 79. The hammer main body portion 78A is tubular. The hammer main body portion 78A is disposed around the spindle shaft portion 60A. The hammer protrusion portions 78B are provided at the front portion of the hammer main body portion 78A. The hammer protrusion portions 78B protrude forward from the front portion of the hammer main body portion 78A. Two hammer protrusion portions 78B are provided around the rotational axis AX.

The hammer main body portion 78A includes a plurality of semi-spherical recessed portions 78C along the circumference of the outer wall. The inner hammer 78 includes a plurality of balls 78D. The balls 78D are made from metal. One ball 78D is disposed in each of the recessed portions 78C. More specifically, the plurality of balls 78D is disposed between the inner hammer 78 and the outer hammer 73, and transmits a rotational force of the inner hammer 78 to the outer hammer 73.

Three hammer grooves 79 are formed on the inner wall of the hammer main body portion 78A. Each of the hammer grooves 79 has a shape narrowed on the rear side and becoming wider as it gets closer to the front side. One hammer groove 79 includes a central hammer groove portion 79A located at the rear end portion of the hammer groove 79, a first hammer groove portion 79B extending from the central hammer groove portion 79A to one circumferential side, and a second hammer groove portion 79C extending from the central hammer groove portion 79A to the other circumferential side. As described above, one ball 62 is disposed between each of the three spindle grooves 61 and each of the three hammer grooves 79. The rotational force of the spindle 60 is transmitted to the inner hammer 78 via the balls 62. The behaviors of the balls 62 and the inner hammer 78 when the spindle 60 rotates will be described below.

The outer hammer 73 is disposed around the inner hammer 78. The outer hammer 73 is tubular. The outer hammer 73 is disposed so as to surround the rotational axis AX. The outer hammer 73 rotates together with the inner hammer 78 in the rotational direction around the rotational axis AX. The outer hammer 73 increases the inertia moment of the impact mechanism 70 by rotating together with the inner hammer 78.

The outer hammer 73 includes a tubular portion 73A, a stepped portion 73B, and a rear end surface portion 73C. The tubular portion 73A extends from the front side to the rear side. The stepped portion 73B is connected to the rear end of the tubular portion 73A, and is smaller in diameter than the tubular portion 73A. The rear end surface portion 73C is an annular surface connected to the rear end of the stepped portion 73B and perpendicularly intersecting with the rotational axis AX. A circular opening portion 73D, which is opened around the rotational axis AX, is formed on the rear end surface portion 73C. The spindle shaft portion 60A of the spindle 60 extends through the opening portion 73D from the rear side to the front side (FIG. 3).

Holding grooves 73E, which guide the balls 78D axially, are formed on the inner surface of the tubular portion 73A of the outer hammer 73. The holding grooves 73E each have a grooved shape extending in the axial direction of the rotational axis AX. A plurality of holding grooves 73E is provided at intervals in the circumferential direction of the inner surface of the tubular portion 73A. The plurality of balls 78D is disposed between the recessed portions 78C of the inner hammer 78 and the holding grooves 73E of the outer hammer 73, respectively, and transmits the rotational force of the inner hammer 78 to the outer hammer 73.

The inner hammer 78 and the outer hammer 73 are relatively movable in the axial direction of the rotational axis AX. The inner hammer 78 moves axially relative to the outer hammer 73 while being guided by the holding grooves 73E of the outer hammer 73 via the balls 78D.

The inner hammer 78 and the outer hammer 73 are fixed relative to each other in the rotational direction around the rotational axis AX by the plurality of balls 78D. When the rotational force is transmitted from the spindle 60 to the inner hammer 78, the plurality of balls 78D transmits the rotational force of the inner hammer 78 to the outer hammer. The inner hammer 78 and the outer hammer 73 rotate together with the rotational axis AX serving as a rotational axis therefor. In other words, the inner hammer 78 and the outer hammer 73 are relatively movable in the axial direction of the rotational axis AX, but are relatively fixed in the rotational direction around the rotational axis AX. As will be described below, the inner hammer 78 moves in the axial direction of the rotational axis AX when the impact tool 1 is driven. Therefore, the inner hammer 78 generates a vibration in the axial direction of the rotational axis AX when the impact tool 1 is driven. However, the outer hammer 73 is fixed immovably relative to the hammer housing 4, and is movable relative to the inner hammer 78 in the axial direction of the rotational axis AX. Therefore, even when the inner hammer 78 vibrates in the axial direction of the rotational axis AX, the outer hammer 73 does not vibrate in the axial direction of the rotational axis AX. As a result, the outer hammer 73 can increase an inertia moment in the rotational direction around the rotational axis AX to increase the impact force of the impact mechanism 70 without increasing the vibration in the axial direction of the rotational axis AX.

The spiral retaining ring 71 and the retainer 72 are disposed between the internal gear 59 and the outer hammer 73. The spiral retaining ring 71 is disposed on the front side of the internal gear 59. The spiral retaining ring 71 is fixed immovably in the front-rear direction by being fixed to the inner wall of the hammer housing 4 under an outward biasing force. The inner diameter of the spiral retaining ring 71 is smaller than the outer diameter of the internal gear 59. Therefore, the spiral retaining ring 71 limits a forward movement of the internal gear 59.

The retainer 72 is disposed in front of the spiral retaining ring 71. The inner diameter of the spiral retaining ring 71 is smaller than the outer diameter of the retainer 72. Therefore, the spiral retaining ring 71 limits a rearward movement of the retainer 72.

A plurality of balls 73F is disposed between the flange portion 60B of the spindle 60 and the rear end surface portion 73C of the outer hammer 73. A circular groove portion movably holding the balls 73F is formed on the rear end surface portion 73C. The balls 73F assist a rotation of the outer hammer 73 relative to the spindle 60.

A plurality of balls 73G is disposed between the stepped portion 73B of the outer hammer 73 and the retainer 72. The stepped portion 73B and the retainer 72 movably hold the plurality of balls 73G. The balls 73G assist a rotation of the outer hammer 73 relative to the retainer 72.

The first coil spring 74, the second coil spring 75, the washer 76, and the support coil spring 77 are disposed between the front surface of the rear end surface portion 73C of the outer hammer 73 and the inner hammer 78. The support coil spring 77 biases the second coil spring 75 rearward via the washer 76. The first coil spring 74 and the second coil spring 75 generate spring forces for moving the inner hammer 78 forward. The support coil spring 77 also has a spring force for moving the inner hammer 78 forward, but is provided mainly for the purpose of supporting the second coil spring 75 under a predetermined spring force so as to prohibit the second coil spring 75 from moving in the front-rear direction. The spring constant of the first coil spring 74 is smaller than the spring constant of the second coil spring 75. The spring constant of the support coil spring 77 is smaller than the spring constant of the first coil spring 74. The ascending order of the spring constant is the support coil spring 77, the first coil spring 74, and the second coil spring 75. The behaviors of the first coil spring 74 and the second coil spring 75 will be described below. This is the configuration of the impact mechanism 70.

The anvil 81 is disposed on the front side the impact mechanism 70. The anvil 81 is connected to the front end of the spindle 60. The anvil 81 rotates by the inner hammer 78 with the rotational axis AX serving as a rotational axis therefor. Further, the anvil 81 is impacted in the rotational direction by the inner hammer 78. The anvil 81 is an output shaft of the impact tool 1 that outputs the rotational force of the motor 40 and the impact force of the impact mechanism 70 to the tool accessory.

The anvil 81 includes an anvil shaft portion 81A and arm portions 81B. The anvil shaft portion 81A has a rod-like shape elongated in the front-rear direction. The central axis of the anvil shaft portion 81A and the rotational axis AX coincide with each other. The arm portions 81B are a pair of protrusion members extending from the rear end portion of the anvil shaft portion 81A radially outward.

An accessory hole 81C is provided on the front end surface of the anvil 81. The accessory hole 81C is formed so as to extend from the front end surface of the anvil shaft portion 81A rearward. The tool accessory is inserted in the accessory hole 81C. The cylindrical anvil protrusion portion 81D, which extends from the front to the rear, is provided on the rear end surface of the anvil 81. The anvil protrusion portion 81D is inserted in the distal-end opening portion 60D provided to the spindle 60.

An anvil bearing 84 and an anvil bearing 86, which are lined up in the front-rear direction, are disposed around the anvil shaft portion 81A on the front side of the anvil 81. The anvil 81 is rotatably supported by the anvil bearing 84 and the anvil bearing 86. The rotational axis of the anvil 81, the rotational axis of the inner hammer 78, the rotational axis of the spindle 60, and the rotational axis AX of the motor 40 coincide with one another. An O-ring 85 is disposed between the anvil bearing 84 and the spindle shaft portion 60A. An O-ring 87 is disposed between the anvil bearing 86 and the spindle shaft portion 60A. The anvil bearing 84 and the anvil bearing 86 are held inside the small tubular portion 4C of the hammer housing 4. The hammer housing 4 supports the anvil 81 via the anvil bearing 84 and the anvil bearing 86.

A spiral retaining ring 82 and a washer 83 are disposed in front of the arm portions 81B. The spiral retaining ring 82 fixes the washer 83 to the hammer housing 4 by being fixed to the inner wall of the hammer housing 4 under an outward biasing force. The spiral retaining ring 82 is disposed out of contact with the anvil 81. The washer 83 and the anvil 81 are in contact with each other. When the motor 40 is actuated to rotate the anvil 81, the washer 83 rotates in reaction to the rotation of the anvil 81.

An accessory holding mechanism 88 is disposed around the front portion of the anvil 81. The accessory holding mechanism 88 holds the tool accessory inserted in the accessory hole 81C of the anvil 81. The tool accessory is detachably attachable to the accessory holding mechanism 88. The accessory holding mechanism 88 is a known technique, and therefore the description thereof will be omitted herein.

### Operation of Impact Tool

Next, the operation when the impact tool 1 is actuated will be described. This operation will be described citing an example when the user engages in the screw tightening work. The tool accessory (a driver bit) used for the screw tightening work by the user is inserted in the accessory hole 81C of the anvil 81. The tool accessory inserted in the accessory hole 81C is held by the accessory holding mechanism 88. After that, the forward-reverse rotation switching lever 27 is operated by the user so as to rotate the motor 40 in the forward direction.

The user operates the trigger lever 26 by pulling it with the grip portion 22 in his/her hand. When the trigger lever 26 is operated by being pulled, electric power is supplied from the battery pack 10 to the motor 40 to actuate the motor 40. Due to the actuation of the motor 40, the rotor shaft 45 of the rotor 44 rotates. When the rotor shaft 45 rotates, the rotational force of the rotor shaft 45 is input to the planetary gear mechanism 50. More specifically, the rotational force of the rotor shaft 45 rotates the pinion gear 58 of the planetary gear mechanism 50. The pinion gear 58 rotates in the same rotational direction as the rotor shaft 45. The shaft of the pinion gear 58 is aligned with the aid of the rear-side rotor bearing 32 supporting the rotor shaft 45, and the front-side rotor bearing 33 supporting the pinion gear 58 itself.

When, the pinion gear 58 rotates, the three planetary gears 57 disposed around the pinion gear 58 rotate on their own axes. As described above, the three planetary gears 57 are supported by the carrier 55. The carrier 55 is fixed so as to be prohibited from rotating by the carrier fixation member 51. Therefore, the planetary gears 57 do not revolve although being rotatable on their own axes. The shaft of each of the planetary gears 57 is aligned with the aid of the gear shaft pin 56 fixed to the carrier 55.

The internal gear 59 rotates due to the rotations of the three planetary gears 57 on their own axes. When being viewed from the direction of the rotational axis AX, the pinion gear 58 and the internal gear 59 rotate in opposite directions from each other. In other words, the rotor 44 of the motor 40 and the internal gear 59 rotate in opposite directions from each other.

The rotational force of the internal gear 59 is transmitted to the spindle 60 connected to the internal gear 59 via the spline. The rotational speed of the spindle 60 is lower than the rotational speed of the rotor 44. The internal gear 59 and the spindle 60 rotate in the same direction as each other. In other words, the rotor 44 of the motor 40 and the spindle 60 rotate in opposite directions from each other.

The rotational force of the spindle 60 is transmitted to the inner hammer 78 via the three balls 62 disposed between the three spindle grooves 61 and the three hammer grooves 79. The spindle 60 and the inner hammer 78 are biased in directions away from each other by the first coil spring 74, the second coil spring 75, and the support coil spring 77. Therefore, the three balls 62 are localized between the central spindle groove portions 61A of the spindle 60 and the central hammer groove portions 79A of the inner hammer 78 initially when the impact tool 1 is started up.

When the rotational force of the spindle 60 is transmitted to the inner hammer 78 via the three balls 62, the inner hammer 78 rotates. The rotational force of the inner hammer 78 is transmitted to the outer hammer 73 via the balls 78D. The outer hammer 73 rotates at a rotational speed equal to the inner hammer 78.

The inner hammer 78 transmits the rotational force to the arm portions 81B of the anvil 81 via the hammer protrusion portions 78B. In other words, the anvil 81 rotates with the hammer protrusion portions 78B and the arm portions 81B in contact with each other. When the spindle 60 rotates (in the forward direction) with the hammer protrusion portions 78B and the arm portions 81B in contact with each other, the anvil 81 rotates together with the inner hammer 78, the outer hammer 73, and the spindle 60. In this case, the anvil 81 rotates without the impact force applied thereto from the inner hammer 78 and the outer hammer 73, and the screw tightening work progresses.

An operation when the progress of the screw tightening work leads to an increase in the load imposed on the anvil 81 and causes the impact force to be applied to the anvil 81 will be described now. First, the functions of the first coil spring 74, the second coil spring 75, and the support coil spring 77 will be described. The biasing forces of these coil springs affect the impact force applied from the inner hammer 78 to the anvil 81. Because the spring constant of the support coil spring 77 is extremely small compared with the first coil spring 74 and the second coil spring 75, substantially, the impact force applied from the inner hammer 78 to the anvil 81 is affected by the first coil spring 74 and the second coil spring 75.

The spring constant of the first coil spring 74 is smaller than the spring constant of the second coil spring 75. If a light load is applied to the anvil 81 in the screw tightening work, the biasing force (the spring force) exerted by the first coil spring 74 is applied to the inner hammer 78. If a heavy load is applied to the anvil 81 in the screw tightening work, the biasing forces (the spring forces) exerted by the first coil spring 74 and the second coil spring 75 are applied to the inner hammer 78.

In the following description, an operation when the impact force is applied to the anvil 81 will be described, separately focusing on examples in two cases one by one. An operation when a load lighter than a predetermined value is applied to the anvil 81 will be described as a first case. An operation when a load equal to or heavier than the predetermined value is applied to the anvil 81 will be described as a second case.

The first case will be described now. In the case where a load lighter than the predetermined value is applied to the anvil 81 according to the progress of the screw tightening work, the anvil 81, the inner hammer 78, and the outer hammer 73 stop rotating. When the spindle 60 rotates with the inner hammer 78 and the outer hammer 73 stopping rotating, the balls 62 move rearward between the second spindle groove portions 61C and the second hammer groove portions 79C against the spring force of the first coil spring 74.

The inner hammer 78 moves rearward under a rearward force from the balls 62. The rearward movement of the inner hammer 78 causes the contact to be released between the hammer protrusion portions 78B and the arm portions 81B. After moving rearward, the inner hammer 78 moves forward while rotating under the spring force of the first coil spring 74. The outer hammer 73 rotates together with the inner hammer 78 although not moving in the front-rear direction.

The anvil 81 is impacted in the rotational direction by the inner hammer 78. The anvil 81 is subjected to the rotational force around the rotational axis AX and the impact force in the rotational direction. The inner hammer 78, which impacts the anvil 81, moves rearward while rotating in the reverse direction due to the impact. The rearward movement of the inner hammer 78 causes the contact to be released between the hammer protrusion portions 78B and the arm portions 81B again. Then, the inner hammer 78 again moves forward while rotating under the spring force of the first coil spring 74, impacting the anvil 81. Due to this series of operations, the impact tool 1 can successively apply the impact force and the rotational force to the screw.

The second case will be described now. In the case where a load equal to or heavier than the predetermined value is applied to the anvil 81 according to the progress of the screw tightening work, the inner hammer 78 initially exhibits a behavior similar to the first case. As the load imposed on the anvil 81 increases, the impact applied to the inner hammer 78 after the anvil 81 is impacted also increases. The anvil 81 rotates in the reverse direction and moves rearward by a greater movement amount than the first case. As such, the inner hammer 78 is also subjected to the spring force of the second coil spring 75 in addition to the spring force of the first coil spring 74. The inner hammer 78 moves forward while rotating under the spring forces of the first coil spring 74 and the second coil spring 75, impacting the anvil 81. Due to this series of operations, the impact tool 1 can apply a stronger impact force and rotational force to the screw than the first case.

The impact tool 1 can start the impact while causing a soft spring (the first coil spring 74) to function at the time of a low load just after the screw tightening work is started. Then, after the load increases, a hard spring (the second coil spring 75) is added to the impact, allowing the screw to be further strongly tightened. This is the operation of the impact tool 1.

In the above-described manner, in the impact tool 1 according to the present embodiment, the planetary gear mechanism 50 is configured to operate as the star type with the carrier 55 non-rotatably fixed. In the case where the planetary gear mechanism 50 operates as the star type, the motor 40, and the internal gear 59 and the spindle 60 rotate in opposite directions from each other. As a result, the present embodiment allows the inertia moment due to the rotation of the motor 40 and the inertia moments due to the rotations of the internal gear 59 and the spindle 60 to cancel out each other, thereby succeeding in suppressing such a phenomenon that the main body of the impact tool 1 is undesirably shaken due to the inertia moments at the beginning of the operation of the impact tool 1 and at the time of a stop of the impact tool 1. As a result, the present embodiment can reduce the load imposed on the user at the time of work using the impact tool 1, improving the usability of the impact tool 1.

In the impact tool 1 according to the present embodiment, the carrier 55 is non-rotatably fixed to the hammer housing 4 via the carrier fixation member 51. Therefore, the carrier 55 can be securely fixed so as to prohibit revolutions of the planetary gears 57 subjected to a strong rotational force from the motor 40 (the pinion gear 58). As a result, the rotational force of the pinion gear 58 can be transmitted to the internal gear 59 without being attenuated due to the planetary gears 57 and the carrier 55. If the carrier 55 is ever fixed weakly, the rotational force from the pinion gear 58 would be unintentionally absorbed by the planetary gears 57 and the rotation force transmitted to the internal gear 59 would also be undesirably attenuated. On the other hand, the present embodiment non-rotatably fixes the carrier 55 to the hammer housing 4 via the carrier fixation member 51, thereby being able to efficiently transmit the rotational force of the pinion gear 58 to the internal gear 59.

The impact tool 1 according to the present embodiment includes the inner hammer 78 disposed around the spindle 60 and rotatable in the same direction as the spindle 60 due to the rotational force of the spindle 60. Further, the impact tool 1 includes the anvil 81 at least partially disposed on the front side with respect to the spindle 60 and configured to be impacted in the rotational direction by the inner hammer 78. Therefore, the present embodiment allows the inertia moment due to the rotation of the motor 40 and the inertia moment due to the rotation of the inner hammer 78 to cancel out each other, thereby succeeding in suppressing such a phenomenon that the main body of the impact tool 1 is undesirably shaken in the rotational direction at the beginning of the operation of the impact tool 1 and at the time of a stop of the impact tool 1. As a result, the present embodiment can reduce the load imposed on the user at the time of work using the impact tool 1, improving the usability of the impact tool 1.

In the present embodiment, the internal gear 59 and the spindle 60 are configured as separate individual members. Therefore, the present embodiment can simplify the manufacturing compared with such a configuration that the internal gear 59 and the spindle 60 are manufactured as an integrated member. Further, the present embodiment makes it easy to use different material as the respective materials of these members, compared with such a configuration that the internal gear 59 and the spindle 60 are formed as an integrated member.

In the present embodiment, the internal gear 59 and the spindle 60 are connected relatively movably in the axial direction of the rotational axis of the internal gear 59 and the spindle 60. Therefore, the present embodiment can suppress the transmission of the vibration generated in the axial direction of the rotational axis from the spindle 60 to the internal gear 59 when the impact tool 1 is driven. As a result, the durability of the planetary gear mechanism 50 can be improved.

In the present embodiment, the internal gear 59 and the spindle 60 are connected via the spline extending in the axial direction of the rotational axis of the internal gear 59 and the spindle 60. Therefore, the present embodiment can achieve a structure excellent in the capability of transmitting the power exerted in the rotational direction from the internal gear 59 to the spindle 60 and the self-aligning ability while suppressing the transmission of the vibration generated in the axial direction of the rotational axis from the spindle 60 to the internal gear 59 when the impact tool 1 is driven.

In the present embodiment, the carrier fixation member 51 includes the gear-shaped first engagement portion 51B with the plurality of teeth formed thereon circumferentially around the pinion gear 58. Then, the hammer housing 4 includes the second engagement portion 4B fitted to the first engagement portion 51B. Therefore, the carrier fixation member 51 is fixed to the hammer housing 4 due to the circumferential gear shape, and this can make it easy for the housing to receive the force of the carrier 55 in the rotational direction. As a result, the carrier 55 can be indirectly fixed to the hammer housing 4 securely.

In the present embodiment, the carrier 55 is a metallic member. The carrier fixation member 51 is a resin member. Therefore, while the carrier 55, to which the force is transmitted from the planetary gears 57, can be enhanced in strength by being formed as a metallic member, the carrier fixation member 51 can be reduced in weight by being formed as a resin member.

Now, the advantageous effects of the present embodiment will be described, comparing them with an electric tool in which the planetary gear mechanism is used in a planetary-type operation mode. In the electric tool with the planetary gear mechanism used in the planetary-type operation mode, the carrier and the spindle may be formed as an integrated member. Forming the carrier and the spindle as an integrated member leads to, for example, manufacturing them by machining a metal material, thus taking considerably many man-hours. Further, the thus-structured electric tool raises the necessity of forming a hollow-structured gear chamber for containing the planetary gears between the carrier and the spindle, thereby complicating the structure. This result in a further increase in the man-hours required for the manufacturing.

On the other hand, the impact tool 1 according to the present embodiment allows the internal gear 59 and the spindle 60 to be separately formed as different individual members, thereby facilitating the manufacturing. Further, a hollow-structured gear chamber for placing the planetary gears does not have to be formed unlike the conventional electric tool. The present embodiment allows the internal gear itself to be used as the gear chamber for placing the planetary gears, thereby achieving the simplification of the structure and a cost reduction. The internal gear 59 according to the present embodiment is widely opened on the rear side thereof, thereby being easily manufactured. When the impact tool 1 is assembled, the present embodiment allows the planetary gears to be mounted just by being placed from the rear side of the internal gear and supported by the gear shaft pins 56, thereby achieving the simplification of the assembling of the impact tool 1. The present embodiment can achieve a reduction in the manufacturing cost.

Further, the impact tool 1 according to the present embodiment eliminates the necessity of a bearing for aligning the shaft of the spindle 60. Therefore, the present embodiment can reduce the number of parts for manufacturing the impact tool 1, achieving the simplification of the structure and a cost reduction.

### B. Second Embodiment

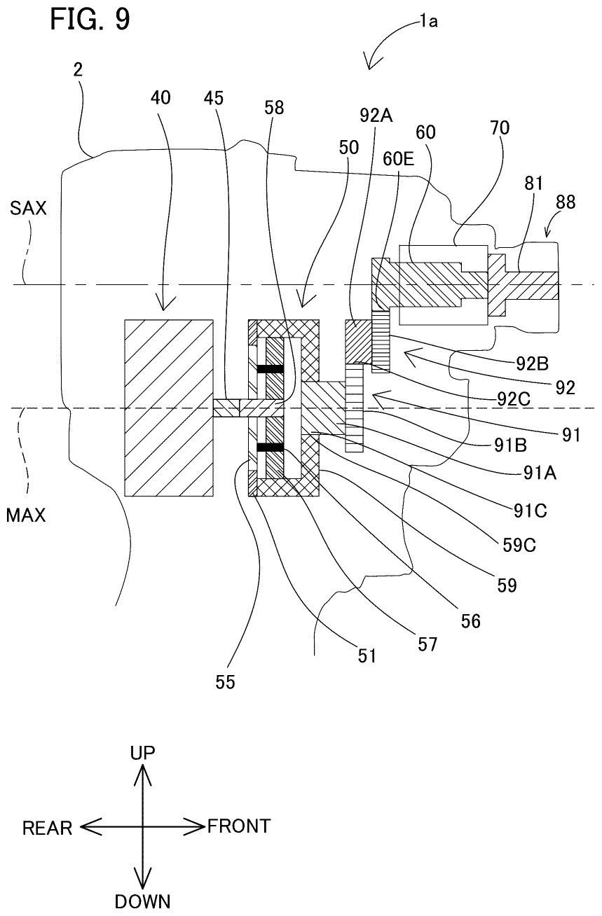

An impact tool 1a according to a second embodiment will be described. FIG. 9 is a diagram schematically illustrating the configuration of the impact tool 1a. A difference between the impact tool 1a and the impact tool 1 is the positional relationship between the axis line of the rotational axis of the motor 40 and the axis line of the rotational axis of the spindle 60. Hereinafter, the rotational axis of the motor 40 will be referred to as a rotational axis MAX. The rotational axis of the spindle 60 will be referred to as a rotational axis SAX. In the impact tool 1 according to the first embodiment, the rotational axis MAX of the motor 40 and the rotational axis SAX of the spindle 60 are located on the same straight line. On the other hand, in the impact tool 1a according to the second embodiment, the rotational axis MAX of the motor 40 and the rotational axis SAX of the spindle 60 extend in parallel with each other. In the following description, the same reference numerals as the first embodiment will be used to indicate mechanisms and members included in the impact tool 1a according to the second embodiment that have the same configuration and function as the mechanisms and the members included in the impact tool 1 according to the first embodiment.

As illustrated in FIG. 9, the impact tool 1a includes the motor 40, the planetary gear mechanism 50, the spindle 60, the impact mechanism 70, a first gear shaft 91, and a second gear shaft 92. The planetary gear mechanism 50 according to the second embodiment is configured to operate as the star type, similarly to the first embodiment. In other words, the pinion gear 58 is rotatable. The planetary gears 57 can rotate on their own axes. The carrier 55 supporting the planetary gears 57 is non-rotatably fixed by the carrier fixation member 51. Since the carrier 55 supporting the planetary gears 57 is non-rotatably fixed, the planetary gears 57 cannot revolve about the pinion gear 58 although being rotatable on their own axes. The internal gear 59 is rotatable. The planetary gear mechanism 50 is configured similarly to the above-described first embodiment, and therefore the detailed description thereof will be omitted here.

The first gear shaft 91 is fitted to the opening portion 59B provided to the internal gear 59. The first gear shaft 91 includes a shaft portion 91A, a gear portion 91B, and a connection portion 91C. The connection portion 91C is disposed at the rear end of the shaft portion 91A, and includes a spline formed thereon. The connection portion 59C provided to the internal gear 59 and the connection portion 91C provided to the first gear shaft 91 are connected via a spline extending in the axial direction of the rotational axis MAX. Therefore, the present embodiment can achieve a structure excellent in the capability of transmitting the power exerted in the rotational direction from the internal gear 59 to the first gear shaft 91 and the self-aligning ability while suppressing the transmission of the vibration generated in the axial direction of the rotational axis MAX from the first gear shaft 91 to the internal gear 59 when the impact tool 1a is driven. The first gear shaft 91 rotates in the same direction as the rotational direction of the internal gear 59. In other words, the first gear shaft 91 rotates in the opposite direction from the rotational direction of the rotor shaft 45.

The first gear shaft 91 transmits a rotational force to the second gear shaft 92. The second gear shaft 92 includes a shaft portion 92A, a front-end gear portion 92B, and a rear-end gear portion 92C. The gear portion 91B of the first gear shaft 91 is disposed at the front end of the shaft portion 91A, and includes a gear formed thereon. The gear portion 91B of the first gear shaft 91 is meshed with the rear-end gear portion 92C of the second gear shaft 92. The first gear shaft 91 transmits the rotational force to the second gear shaft 92 via the gear portion 91B and the rear-end gear portion 92C. The first gear shaft 91 and the second gear shaft 92 rotate in opposite directions from each other.

The second gear shaft 92 is connected to the spindle 60. The front-end gear portion 92B provided to the second gear shaft 92 is meshed with a spindle gear portion 60E provided to the spindle 60. A rotational force of the second gear shaft 92 is transmitted to the spindle 60 via the front-end gear portion 92B and the spindle gear portion 60E. The spindle 60 rotates in an opposite direction from the rotational direction of the second gear shaft 92. In other words, the spindle 60 rotates in an opposite direction from the rotational direction of the rotor shaft 45 (the motor 40). The spindle 60 rotates in the same direction as the rotational directions of the internal gear 59 and the first gear shaft 91.

The rotational force of the spindle 60 is transmitted to the impact mechanism 70, the anvil 81, and the tool accessory in a similar manner to the first embodiment, and therefore the description thereof will be omitted here.

In the above-described manner, in the impact tool 1a according to the present embodiment, the planetary gear mechanism 50 is configured to operate as the star type with the carrier 55 non-rotatably fixed. In the case where the planetary gear mechanism 50 operates as the star type, the motor 40 and the internal gear 59 rotate in opposite directions from each other. Further, in the impact tool 1a, the rotational force of the internal gear 59 is transmitted to the spindle 60 via the first gear shaft 91 and the second gear shaft 92. As a result, in the impact tool 1a, the motor 40, and the internal gear 59 and the spindle 60 also rotate in opposite directions from each other similarly to the first embodiment. As a result, the present embodiment allows the inertia moment due to the rotation of the motor 40 and the inertia moments due to the rotations of the internal gear 59 and the spindle 60 to cancel out each other, thereby succeeding in suppressing such a phenomenon that the main body of the impact tool 1a is undesirably shaken due to the inertia moments at the beginning of the operation of the impact tool 1a and at the time of a stop of the impact tool 1a. As a result, the present embodiment can reduce the load imposed on the user at the time of work using the impact tool 1a. The present embodiment can improve the usability of the impact tool 1a.

The impact tool 1a according to the second embodiment includes the inner hammer 78 disposed around the spindle 60 and rotatable in the same direction as the spindle 60 due to the rotational force of the spindle 60, similarly to the above-described first embodiment. Further, the impact tool 1a includes the anvil 81 at least partially disposed on the front side with respect to the spindle 60 and configured to be impacted in the rotational direction by the inner hammer 78. Therefore, the present embodiment allows the inertia moment due to the rotation of the motor 40 and the inertia moment due to the rotation of the inner hammer 78 to cancel out each other, thereby succeeding in suppressing such a phenomenon that the main body of the impact tool 1a is undesirably shaken in the rotational direction at the beginning of the operation of the impact tool 1a and at the time of a stop of the impact tool 1a. As a result, the present embodiment can reduce the load imposed on the user at the time of work using the impact tool 1a. The present embodiment can improve the usability of the impact tool 1a.

In the impact tool 1a according to the second embodiment, the internal gear 59 and the spindle 60 are configured as separate individual members, similarly to the above-described first embodiment. Therefore, the present embodiment can simplify the manufacturing compared with such a configuration that the internal gear 59 and the spindle 60 are manufactured as an integrated member. Further, the present embodiment makes it easy to use different material as the respective materials of these members, compared with such a configuration that the internal gear 59 and the spindle 60 are formed as an integrated member. Other than that, the impact tool 1a according to the second embodiment brings about similar advantageous effects to the impact tool 1 according to the above-described first embodiment.

The corresponding relationship between each component (feature) in the above-described embodiments and each component (feature) of the present disclosure or invention will be described below. However, each component in the embodiments is merely one example and shall not limit each component of the present disclosure or the present invention.

The impact tool 1 and the impact tool 1a are each one example of an “electric tool”. The motor 40 is one example of a “motor”. The spindle 60 is one example of a “spindle”. The planetary gear mechanism 50 is one example of a “planetary gear mechanism”. The pinion gear 58 is one example of a “sun gear”. The planetary gear 57 is one example of a “planetary gear”. The internal gear 59 is one example of an “internal gear”. The carrier 55 is one example of a “carrier”. The carrier fixation member 51 is one example of a “carrier fixation member”. The hammer housing 4 is one example of a “housing”. The spline formed on the connection portion 59C and the connection portion 60C is one example of a “spline”. The first engagement portion 51B is one example of a “first engagement portion”. The second engagement portion 4B is one example of a “second engagement portion”. The inner hammer 78 is one example of a “hammer”. The anvil 81 is one example of an “anvil”.

The above-described embodiments are merely indicated as exemplification, and the electric tool according to the present disclosure shall not be limited to the exemplified impact tool 1 and impact tool 1a. For example, non-limiting changes that will be exemplified below can be added. Further, at least one of these changes can be employed in combination with any of the impact tool 1 and the impact tool 1a exemplified in the embodiments and the inventions recited in the claims.

For example, the electric tool is not limited to the impact tool, and various electric tools can be employed as long as the employed electric tool is configured in such a manner that the rotational axis of the motor and the rotational axis of the spindle are disposed in parallel with each other or on the same straight line, like a drill driver and a drill. Further, various electric tools can be employed as the impact tool as long as the employed electric tool applies an impact in a rotational direction, like an impact driver and an impact wrench.

The carrier 55 does not have to be fixed by the carrier fixation member 51 as long as it is non-rotatably fixed. For example, the carrier 55 itself may be shaped fixably to an external housing.

The internal gear 59 and the spindle 60 do not have to be configured as separate individual members. A configuration forming the internal gear 59 and the spindle 60 as an integrated member may be employed. For example, the internal gear 59 and the spindle 60 may be manufactured as an integrated member by machining a metal material. The internal gear 59 and the spindle 60 can be enhanced in rigidity.

The connection between the internal gear 59 and the spindle 60 is not limited to the spline. Another configuration may be employed as long as the internal gear 59 and the spindle 60 are connected relatively movably in the axial direction of the rotational axis thereof. Examples of employable connections include a connection using a keyway, and a connection using hexagonal protrusion and recessed portions.

The carrier fixation member 51 is not limited to being made of a resin member. The carrier fixation member 51 may be made of a metallic member.

### DESCRIPTION OF THE REFERENCE NUMERALS

1, 1a: impact tool, 2: main body housing, 2S: screw, 3: rear cover, 4: hammer housing, 4B: second engagement portion, 4C: small tubular portion, 10: battery pack, 21: motor containing portion, 22: grip portion, 23: battery holding portion, 24: intake port, 25: exhaust port, 26: trigger lever, 27: forward-reverse rotation switching lever, 28: battery mount portion, 29: controller, 31: fan, 32: rear-side rotor bearing, 33: front-side rotor bearing, 40: motor, 41: stator, 42: stator core, 43: coil, 44: rotor, 45: rotor shaft, 46: rotor core, 47: rotor magnet, 48: sensor magnet, 49: sensor board, 50: planetary gear mechanism, 51: carrier fixation member, 51A: holding portion, 51B: first engagement portion, 53: O-ring, 55: carrier, 55A: opening portion, 55B: bearing fixation portion, 56: gear shaft pin, 57: planetary gear, 58: pinion gear, 59: internal gear, 59A: inner wall, 59B: opening portion, 59C: connection portion, 60: spindle, 60A: spindle shaft portion, 60B: flange portion, 60C: connection portion, 60D: distal-end opening portion, 60E: spindle gear portion, 61: spindle groove, 61A: central spindle groove portion, 61B: first spindle groove portion, 61C: second spindle groove portion, 62: ball, 70: impact mechanism, 71: spiral retaining ring, 72: retainer, 73: outer hammer, 73A: tubular portion, 73B: stepped portion, 73C: rear-end surface portion, 73D: opening portion, 73E: holding groove, 73F: ball, 73G: ball, 74: first coil spring, 75: second coil spring, 76: washer, 77: support coil spring, 78: inner hammer, 78A: hammer main body portion, 78B: hammer protrusion portion, 78C: recessed portion, 78D: ball, 79: hammer groove, 79A: central hammer groove portion, 79B: first hammer groove portion, 79C: second hammer groove portion, 81: anvil, 81A: anvil shaft portion, 81B: arm portion, 81C: accessory hole, 81D: anvil protrusion portion, 82: spiral retaining ring, 83: washer, 84: anvil bearing, 85: O-ring, 86: anvil bearing, 87: O-ring, 88: accessory holding mechanism, 91: first gear shaft, 91A: shaft portion, 91B: gear portion, 91C: connection portion, 92: second gear shaft, 92A: shaft portion, 92B: front-end gear portion, 92C: rear-end gear portion, AX: rotational axis, MAX: rotational axis, SAX: rotational axis

1. An electric tool comprising:
a motor;
a spindle configured to rotate due to a rotational force transmitted from the motor;
a planetary gear mechanism configured to transmit the rotational force of the motor to the spindle; and
a housing containing at least a part of the planetary gear mechanism,
wherein a rotational axis of the motor and a rotational axis of the spindle are disposed on a same straight line, and
wherein the planetary gear mechanism includes
a sun gear to which the rotational force from the motor is input,
a plurality of planetary gears disposed on a radially outer side around a rotational axis of the sun gear,
a carrier provided non-rotatably relative to the housing and configured to support the plurality of planetary gears rotatably on their own axes, and
an internal gear rotatably disposed on the radially outer side of the plurality of planetary gears and configured to transmit the rotational force to the spindle.

2. The electric tool according to claim 1, further comprising a carrier fixation member configured to non-rotatably fix the carrier to the housing.

3. The electric tool according to claim 2, wherein the carrier fixation member includes a gear-shaped first engagement portion on which a plurality of teeth is formed circumferentially around the rotational axis of the sun gear, and
wherein the housing includes a second engagement portion fittable to the first engagement portion.

4. The electric tool according to claim 2, wherein the carrier is a metal member, and
wherein the carrier fixation member is a resin member.

5. The electric tool according to claim 1, wherein the internal gear and the spindle are configured as separate individual members.

6. The electric tool according to claim 1, wherein the internal gear and the spindle are connected relatively movably in an axial direction of a rotational axis of the internal gear and the spindle.

7. The electric tool according to claim 1, wherein the internal gear and the spindle are connected via a spline extending in the axial direction of the rotational axis of the internal gear and the spindle.

8. The electric tool according to claim 1, further comprising:
a hammer disposed around the spindle and provided rotatably in the same direction as the spindle due to a rotational force of the spindle; and
an anvil at least partially disposed on a front side with respect to the spindle and configured to be impacted in a rotational direction by the hammer.

9. The electric tool according to claim 8, wherein the motor and the spindle rotate in opposite directions from each other.

10. The electric tool according to claim 1, wherein the motor and the spindle rotate in opposite directions from each other.

11. An electric tool comprising:
a motor; and
a spindle configured to rotate due to a rotational force transmitted from the motor,
wherein a rotational axis of the motor and a rotational axis of the spindle are disposed in parallel with each other or on a same straight line, and
wherein the motor and the spindle rotate in opposite directions from each other.

12. The electric tool according to claim 11, further comprising a planetary gear mechanism configured to transmit the rotational force of the motor to the spindle,
wherein the planetary gear mechanism includes a sun gear, a planetary gear, a carrier supporting the planetary gear rotatably on its own axis, and an internal gear,
wherein the rotational force of the motor is input to the sun gear,
wherein the carrier is non-rotatably fixed,
wherein the internal gear is rotatable, and
wherein a rotational force of the internal gear is output to the spindle.

13. The electric tool according to claim 12, further comprising:
a hammer disposed around the spindle and provided rotatably in the same direction as the spindle due to a rotational force of the spindle; and
an anvil at least partially disposed on a front side with respect to the spindle and configured to be impacted in a rotational direction by the hammer.

14. The electric tool according to claim 11, further comprising:
a hammer disposed around the spindle and provided rotatably in the same direction as the spindle due to a rotational force of the spindle; and
an anvil at least partially disposed on a front side with respect to the spindle and configured to be impacted in a rotational direction by the hammer.
